(19) United States
(12) Patent Application Publication
(10) Pub. No.: US 2009/0106788 A1
(43) Pub. Date: Apr. 23, 2009

(54) Procedure for Authenticating a Digital-Content User

(76) Inventor: Alain Nochimowski, Paris (FR)

Correspondence Address: Baker & Hostetler LLP;Attn: Jim Coffman, 45 Rockefeller Plaza, New York, NY, 10111, US

(21) Appl. No.: 11/887,193

(22) PCT Filed: Apr. 4, 2006
(86) PCT No.: PCT/FR2006/050295

§ 371 Date: Sep. 26, 2007

(30) Foreign Application Priority Data
Apr. 6, 2005 (FR) 05 03418

(51) Int. Cl. H04N 7/16

(52) U.S. Cl. 725/25

(57) ABSTRACT

The invention concerns a method for authenticating a user possessing a right of access to a digital content via terminal equipment (8).

This method includes:
a configuration phase consisting of assigning to the user, via a ‘trust’ third party, an exclusive reference independent of the terminal equipment, previously correlated with a user identifier,
a phase in which the afore-mentioned identifier is associated with a condition for accessing the said content,
a verification phase executed locally at the terminal equipment, consisting of verifying a predefined correlation between information supplied by the user and the reference assigned to the user and designated by the said identifier, and
a decision-making phase executed locally in the terminal equipment and consisting of authorizing or prohibiting access to content according to the result of the above verification.

### FIELD OF THE INVENTION

The invention pertains to the field of digital content protection and more specifically concerns a method for authenticating a user having a right to access a digital content using terminal equipment

The invention applies in the context of distribution networks in connected mode or broadcast mode (Internet, mobile telephony, broadcast by satellite, xDSL, . . . ) in which exchanged content is protected by a digital rights management system (DRM, Digital Rights Management) or by a classical Conditional Access System (CAS).

### STATE OF TECHNOLOGY HITHERTO

In current content distribution systems and in the context of distributed networks, the recipient of a digital content (subscriber, purchaser) is assimilated to his terminal and is identified by means of information related to the terminal equipment intended to receive such content, for example the IP (Internet Protocol) address, the computer serial number, a telephone number, the unique identifier of the TV decoder or the unique address of a chip card associated with the TV decoder, . . . . The digital content is distributed to the recipient after it has been processed by at least one parameter depending on one piece of this information.

FIG. 1 illustrates schematically the classical architecture of a distribution system for content protected by a DRM licence.

This architecture consists of a content server 2 associated with a module 4 for formatting this content and a licences server 6. The user's receiver equipment 8 consists of a DRM agent 10, a content reader/decoder 12 and a module 13 for dialoguing with the user.

The content server 2 receives (arrow 14) an encrypted content suitable for DRM format from the formatting module 4, and sends (arrow 15) this content to the DRM agent 10.

The licenses server 6 receives (arrow 16) from the formatting module 4 information on formatting the content, such as the cryptographic key for de-encrypting this content, and sends (arrow 18) the licence associated with the content to the terminal equipment, thereby ensuring that use of the digital content is managed and controlled.

Let us recall that a DRM licence consists of the juxtaposition of information on the content, especially its identifier and possibly the cryptographic key enabling it to be decoded, and information on authorisations and constraints on the use of content (number of readings, copying rights, end date or period of utilisation, recipient(s) of the content, etc. . . . ).

In the receiver equipment 8 the DRM agent 10 checks that the user rights are compatible with the DRM licence. Subject to an authorisation supplied by the DRM agent 10, the content reader 12 enables access to the protected content and delivers this content in a decoded form.

When deploying a DRM system, the desire is to restrict access to content to a duly authorized user or to a specific group that is strictly limited to such users. However, on a technical level, in the well-known DRM systems, the content user licence is encoded by a unique key specific to the user's equipment or to a limited and strictly defined group of equipment. This licence may only be used by the DRM agent situated in this equipment or in one of the pieces of equipment of the group. In other words, a user licence is structurally connected to a piece of equipment and not to the actual person to whom the licence has been granted. Hence, a DRM system assimilates the user to his equipment.

Consequently, a DRM licence linked to a piece of terminal equipment enables a priori use of the content by all individuals with access to this equipment.

Thus the digital content may be used in the event of theft or loss of the terminal equipment, if the equipment is loaned or if it is shared by members of a group.

Furthermore, this content is not accessible to the recipient on any terminal equipment unknown by the content provider or that has not been previously configured with information specific to the equipment declared by the licence holder.

Moreover, formatting the digital content by parameters specific to a particular piece of equipment of the licence holder generates a strong dependency between the operator supplying the content and this equipment for use of the content concerned, whereas the user may wish to have access to the content on another piece of his equipment without having to refer to the operator.

FIG. 2 provides a schematic illustration of the classical architecture of a system for distributing content protected by a Conditional Access System (CAS).

This architecture consists of a content formatting module 20 to which is connected a conditional access management module 22. In this case, the user's receiver equipment 8 consists of a conditional access module 24 and a security processor 26, such as a chip card.

The conditional access management module 22 generates ECM messages (=Entitlement Control Message) containing the conditions for accessing content and its descrambling key, usually called control word (CW), and sends these messages (arrow 28) to the formatting module 20. By means of encryption the latter converts the content into a protected content to which are associated the ECM access-condition messages.

The conditional access management module 22 also generates EMM messages (=Entitlement Management Message) and sends these messages (arrow 30) to terminal 8 to manage the access rights obtained by the user. Hence, the access rights or means of obtaining them (tokens for the impulsive PPV request, (Pay Per View) are handled and entered remotely by the operator into a non-volatile memory of the security processor 26.

In the terminal equipment 8 the conditional access module 24 consists of a first module 32 for processing ECM and EMM messages in collaboration with the security processor 26. Other additional processing for special functions, such as the impulsive purchase of a PPV program, which require the user's consent are handled by a second processing module 34. When the conditions for accessing the content defined in the ECMs are met, the conditional access module 24 provides the data to the terminal 8—typically the control word (CW)—enabling the latter to descramble the content and to return the content unscrambled to the user. The terminal 8 also has a module 36 for dialoguing with the user.

In some well-known CAS systems, such as those meeting norm NF EN 50094 ‘Eurocrypt’, the ECM and EMM messages are sent to the subscriber's receiving system by targeting his security processor 26:
Individually via his unique address (UA)
As a group member via his group address;
Indiscriminately via the global address of the security processors belonging to the CAS supplier.

Other forms of addressing the subscriber's receiving system may be used, such as addressing the terminal equipment individually, by group or otherwise.

Thus, as in a DRM system, a CAS system assimilates the user to his equipment.

In all cases, the solutions described above have the following disadvantages:
the digital content may be used if the terminal equipment 8 is stolen or if this equipment is loaned;
the digital content may be used by every member of the group sharing the equipment if the terminal equipment 8 is shared;
the content is not accessible to its recipient on any terminal equipment unknown by the supplier of the content or that has not been previously configured with information specific to a piece of equipment which the holder of the access licences wishes to use;
formatting the digital content by parameters specific to a particular piece of equipment of the access licence holder generates a strong dependency between the supplier of the content and this particular equipment.

An initial aim of this invention is to restrict access to digital content to the actual person holding the DRM licence or access rights alone.

A second aim of the invention is to allow this person to access to the content via any terminal equipment without this equipment having to have been previously registered with the supplier of the content or configured by him.

A third aim is to prohibit any person other than the licence holder from accessing the said content by means of terminal equipment deemed to be held by the latter.

### PRESENTATION OF THE INVENTION

These aims are attained by means of a procedure in which managing authorisations for accessing content is shared with an independent identity management system capable of providing authentication of the identity of the authorized user, with the consent of the user.

To this end, the invention recommends a procedure for authenticating a user possessing an access right to a digital content by means of a terminal equipment, said procedure comprising:
a configuration phase consisting of assigning to the user, via a trusted third party, an exclusive reference independent of the terminal equipment and previously correlated with an identifier of the user, and in one-to-one relation with the personal information which the user should supply in order to be authenticated,
a phase in which the afore-mentioned user identifier is associated with a condition for accessing the said content,
a verification phase executed locally at the terminal equipment, consisting of verifying the above-mentioned one-to-one relation between the personal information supplied by the user and the reference assigned to the user, and
a decision-making phase executed locally in the terminal equipment and consisting of authorizing or prohibiting access to content according to the result of the above verification.

In a first implementation, the verification phase is activated in response to the condition for accessing the content.

Verification of the predefined correlation between the information supplied by the user and the reference assigned to said user and designated by the identifier present in the access condition is executed on the basis of a security level agreed by the supplier of the right of access and the identity server.

This correlation may be a strict equality between the information supplied by the user and the reference assigned to said user.

In another example, this correlation may be an equality between the reference assigned to the user and a cryptographic digest assembled from the information provided by this user.

The afore-mentioned reference should preferably be stored in a remote autonomous identity server. In this case the verification phase should preferably be executed by the remote identity server at the request of the terminal equipment.

In a particular implementation, the external reference is stored on a secured detachable support associated with the terminal equipment. In this case, the verification phase should preferably be executed by a security processor, such as a chip card containing security software associated locally with the terminal equipment.

When applying the procedure according to the invention, the digital content may represent audio data, video data or multimedia data.

In this application the content may be encoded and its use in the terminal equipment may be subject to access conditions contained in a DRM licence or sent in ECM messages.

The invention also concerns a terminal equipment intended to receive digital content. This equipment consists of a control module of a user's right of access to the digital content and a ‘trust’ module cooperating with an identity server to authenticate the user with respect to an independent reference of the terminal equipment.

### BRIEF DESCRIPTION OF THE DRAWINGS

Other characteristics and advantages of the invention will be more apparent from the following description, given by way of example, with reference to the annexed diagrams including:

FIG. 1, described above, is a schematic representation of a system architecture for distributing content protected by a DRM licence;

FIG. 2, described above, is a schematic representation of a system architecture for distributing content protected by a CAS;

FIG. 3 is a schematic representation of a system architecture for distributing content protected by a DRM licence in which the procedure from the invention is deployed;

FIG. 4 is a schematic representation of an initial means of setting up terminal equipment in which the procedure is deployed according to the invention, in the event that the content is protected by a DRM licence;

FIG. 5 is a schematic representation of the different stages of the process for authenticating the user of content protected by a DRM licence according to the invention;

FIG. 6 is a schematic representation of another means of setting up terminal equipment in which the procedure is deployed according to the invention, in the event that the content is protected by a DRM licence;

FIG. 7 shows a first embodiment of a terminal equipment in which the procedure is deployed according to the invention, in the event that the content is protected by a CAS;

FIG. 8 is a schematic representation of another embodiment of a terminal equipment in which the procedure is deployed according to the invention, in the event that the content is protected by a CAS.

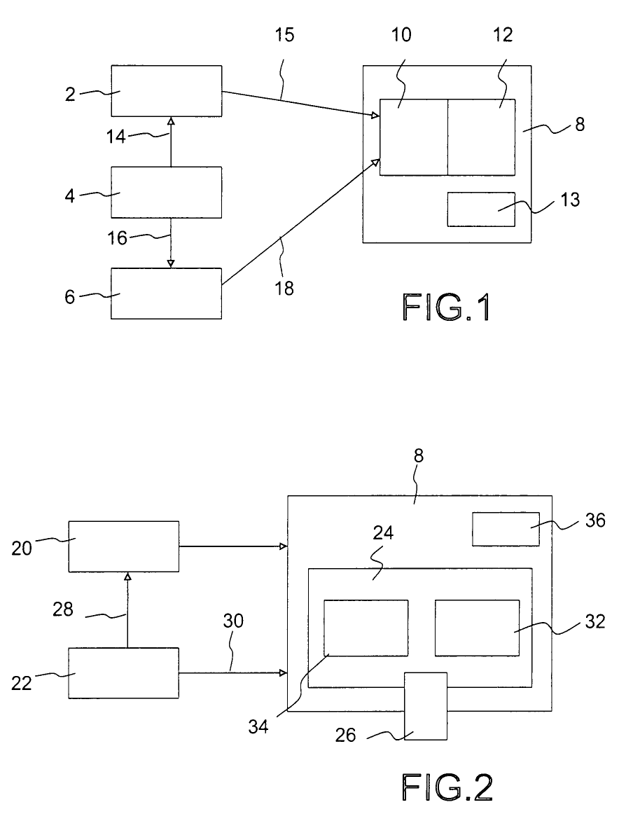

### DETAILED PRESENTATION OF PARTICULAR SET-UPS

In the description that follows identical references will designate the elements common to the architectures of the prior art systems and to the architectures of the various embodiments of the invention.

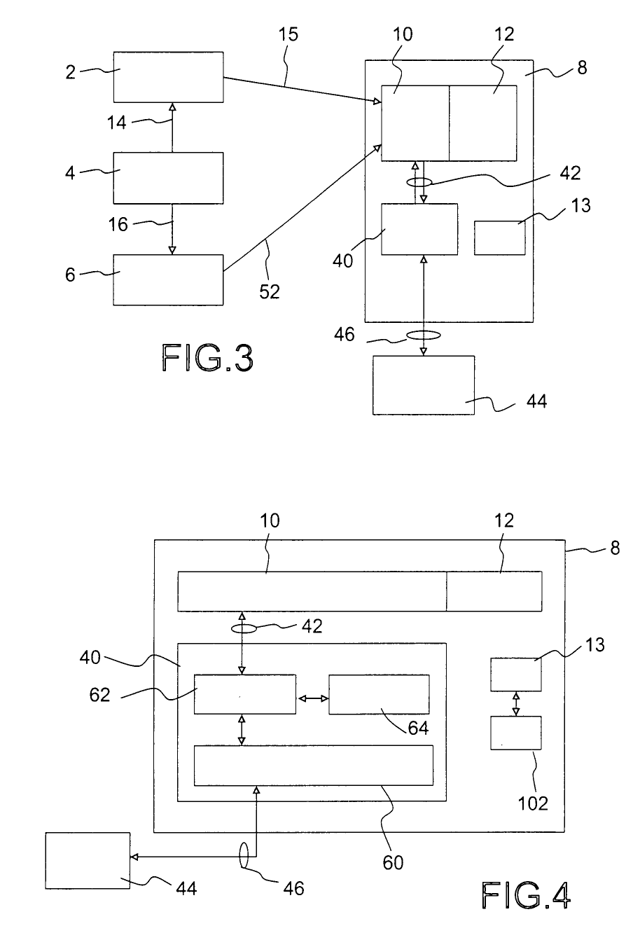

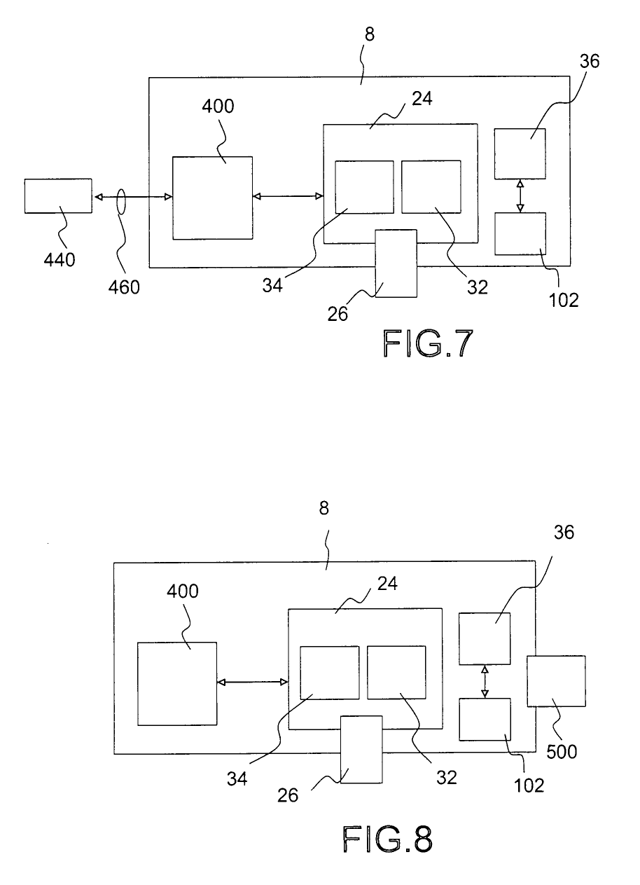

Detail is given of applying the invention in the DRM context as per FIGS. 3, 4, 5 and 6, and in the CAS context as per FIGS. 7 and 8.

The architecture described in FIG. 3 comprises, at the Head End, resources for executing additional processing of the content by taking account of the recipient user's identity. These resources are integrated into module 4 which formats the protected content. At the down send, the terminal equipment has the means to interpret such processing.

More specifically, the terminal equipment contains a ‘trust’ module 40 intended to verify the user's identity. At a functional level module 40 is connected, on the one hand, to the DRM agent 10 via an interface 42 and, on the other hand, to an identity server 44 via an interface 46. This interface 46 may be deployed by means of a bidirectional link, such as that present in an xDSL or telephone network, or by means of a backward channel or an ascending channel in the case of a distribution network.

In the architecture illustrated in FIG. 3, the licence server 6 is separated from the identity server 44, because managing access rights is functionally separate from managing user identities. Indeed, these two servers bear two distinct responsibilities: on the one hand the licence operator which handles access to the content by verifying the licence via the server 6, and on the other hand the identity operator which, as ‘trust’ third party, handles user identities to be authenticated via the identity server 44.

In the configuration phase, prior to any dispatch of content to a user, the identity server 44 allocates the user an exclusive reference independent of terminal equipment 8 and previously correlated with an identifier of this user. This reference is in a one-to-one relation with information that the user should supply for authentication. This correlation is predefined and consists, for example, of a strict equality of the information with the reference, or of an equality of a cryptographic digest of information supplied by the user with the reference, or of any other one-to-one relation between these two values.

Subsequently, when using a content, the DRM agent 10 activates the ‘trust’ module 40 to check the user's identity. To this end, the ‘trust’ module 40 asks the user for information about his identity. To authenticate the user designated by the identifier present in the DRM licence, the ‘trust’ module 40 verifies the correlation between the information provided by the user and the reference allocated to this user and designated by the identifier present in the access condition.

Hence, the ‘trust’ module 40 integrated into the terminal 8 checks that the user of the content is actually the authorized recipient. To do this, in addition to the usual functions of a DRM when checking access to content, including in particular the identifier of the content, its decoding key and the authorisations and constraints associated with it, the licence issued (arrow 52) by the licence server 6 contains additional information on the identity of the recipient and the desired level of security for authenticating this recipient.

The validity of a recipient's identity is linked to the trust domain in which this identity is defined. A trust domain is the domain in which the authority of a ‘trust’ third party is exercised. Handling the user's identity depends on the relationship between licence operators and ‘trust’ third parties. Hence, within a single trust domain a recipient has the same identity for several licence operators referring to this same domain. If this recipient has recourse to licence operators linked to different trust domains, he will have as many different identities as domains. A specific licence operator will then reference him by his identity relating to the trust domain corresponding to that operator. Conversely, if an identity federation mechanism is implemented, the recipient may be authenticated by any of the identities thus federated. The invention applies to these various cases of definition and, whatever the case, the identity of a future user can be created spontaneously at a user's request but always under the exclusive control of a ‘trust’ third party.

The recipient's authentication security level is defined by an authentication context, for example a set of parameters contributing to the identity authentication function, such as the size of encryption keys, user registration conditions, key container security, etc. . . . An authentication context is agreed by the licence server applying it and the identity server operating it to authenticate the user's identity. In a licence, the authentication context used is described explicitly or by designating a context agreed by the licence operator supplying the right of access and the identity operator.

FIG. 4 is a schematic representation of terminal equipment 8 intended to receive content protected by a DRM licence.

As shown in this figure, the ‘trust’ module 40 is physically integrated into the terminal equipment 8 and contains a download module 60 linked to an identity server 44, an interpretation module 62 and a cache memory 64. The terminal may also contain a biometric sensor 102, such as a fingerprint reader, iris scanner or voice-print analyser, etc. In that case, the identity check activated by the ‘trust’ module 40 effects a biometric data check via the dialogue module 13.

Operation within the terminal equipment will be described by means of an example in which a user B is designated as the recipient of a licence including an obligation to verify that the user is indeed user B. The identity ID_B of user B has been agreed with the identity server 44 and is recognized by the licences server 6 (not shown in this diagram).

The licences server 6 issues a licence indicating the identifier ID_B of the licence recipient and the desired authentication context (AuthCtxt). The DRM agent 10 interprets the approved licence to check whether this licence meets the following conditions:
the user is indeed B;
he is authenticated with the security level stipulated in the desired authentication context(AuthCtxt).

Verification of the conditions linked to the user's identity should preferably be delegated to the ‘trust’ module 40. To this end, the DRM agent 10 sends to the ‘trust’ module 40, via the interface 42, a request asking it to verify that the user is indeed B (ID_B) with the desired authentication context(AuthCtxt).

In an implementation of the invention, the request may ask for the user's identity to be verified without specifying his expected ID_B value.

In another implementation, the request originating from the DRM agent 10 also includes a piece of information (AuthTime) corresponding to the final validity date of the authentication. Thus, an assertion of authentication may be considered no longer valid if it is made beyond a certain time or date.

Yet, in an other embodiment, the DRM agent 10 checks that the data [ID_B, AuthCtxt, AuthTime] supplied in the licence indeed correspond to those collected by the ‘trust’ module 40 in the assertion signed and time-stamped of the identity server 44.

More precisely, a minimum of the following data are supplied to the ‘trust’ module 40 via the interface 42:

address of the identity server 44 to be contacted,

the ID_B identifier,

the AuthCtxt information,

the AuthTime information,

the identifier of the licences server 6.

The address of the identity server 44 is used by the download module 60 to dialogue with this server. It is to be noted that this address may be passed to the ‘trust’ module 40 in advance.

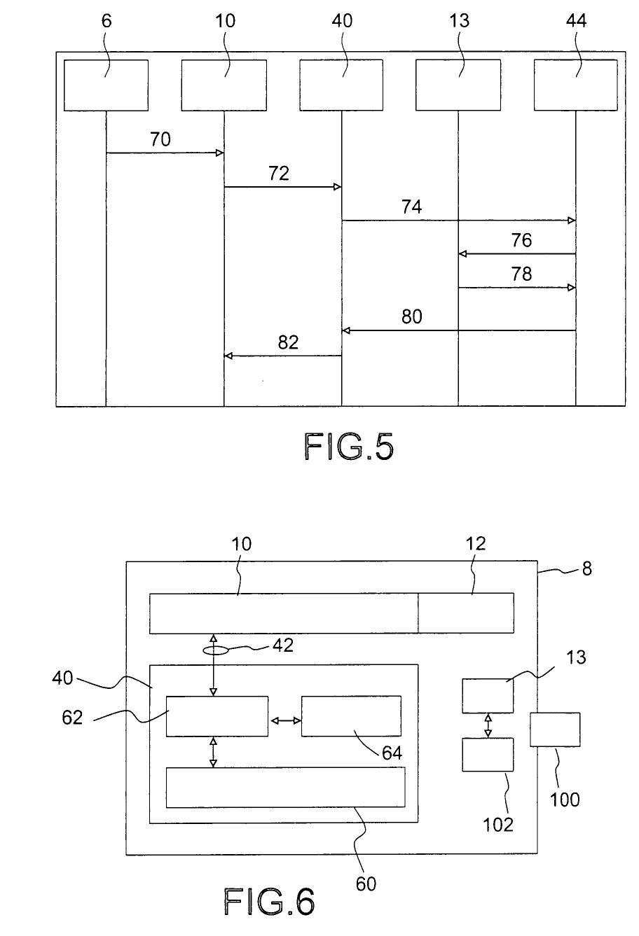

FIG. 5 is a schematic illustration of the various stages of the authentication process for user B of a content protected by a DRM licence.

The licences server 6 sends the licence pertaining to the content to the DRM agent 10 (arrow 70).

The DRM agent 10 sends to the ‘trust’ module 40 (arrow 72), via the interface 42, a request asking it to verify that the user is indeed B (ID_B) with the desired authentication context (AuthCtxt).

The ‘trust’ module 40 sends an authentication request AuthRequest to the identity server 44 (arrow 74), via the interface 46.

A session is then established between the identity server 44 and user B, for example with the assistance of the dialogue module 13.

The identity server 44 requests (arrow 76) personal information on the user which should correlate with the reference allocated to user B and designated by the identifier ID_B.

User B provides (arrow 78) this personal information, via the entry interface 13 integrated into the equipment 8.

The identity server 44 checks that the user information corresponds to the reference and then replies to the ‘trust’ module 40 (arrow 80), passing to it a signed assertion containing the identifier of B and the validated level of authentication: [ID_B; AuthCtxt]_{signed}. This assertion may be stored locally in the cache memory 64 of the ‘trust’ module 40 (FIG. 4) to be reused according to need at dates prior to AuthTime, without having to initiate a new session with the identity server 44.

Finally, the ‘trust’ module 40 sends (arrow 82) the reply received from the identity server 44 or extracted from the cache memory 64 to the DRM agent 10. This reply specifies whether the user has or has not been authenticated with the desired security level as user B of the licence. The DRM agent 10 then uses this reply from the ‘trust’ module 40 with the other authorisations or constraints contained in the licence to authorize or prohibit access to the content.

FIG. 6 is a schematic representation of another variant in which the ‘trust’ module 40 handles verification of the user's identity locally at the terminal, without contacting a remote identity server. In this architecture, the terminal also includes an external secured support 100 such as, for example, a chip card connected to the terminal for the occasion. Verification is made with respect to an independent user reference of the terminal 8 that has previously been stored on the external support 100 and that is designated by the identifier present in the access condition. The terminal may also contain a biometric sensor 102 having the same function as in the case shown in FIG. 4.

FIG. 7 is a schematic presentation of an architecture in which the content is protected by a CAS.

In this figure the terminal 8 possesses a ‘trust’ module 400 which is structured and operates as the corresponding module in the DRM context described above. In the architecture described in FIG. 7 the ‘trust’ module 400 is connected to a remote identity server 440 via a link 460. Additionally, the terminal may include a biometric sensor 102, such as for example a fingerprint reader, an iris scanner or a voice-print analyser, etc. . . .

In this case, the identity check activated by the ‘trust’ module 400 deploys a biometric data check via the dialogue module 13.

When an access condition attached to a content includes checking the user's identity, the CAS module 24 in the terminal 8 issues a user authentication request to the ‘trust’ module 400 which returns a positive or negative authentication reply according to the security level described in the access condition or attached to the dialogue phase concerned. The CAS module 24 then decides on whether to pursue the access or dialogue with the user on the basis of this reply sent by the ‘trust’ module 400.

FIG. 8 provides a schematic representation of another variant in which the ‘trust’ module 400 handles verification of the user's identity locally at the terminal, without contacting a remote identity server. In this variant, the terminal also includes an external secured support 500 such as, for example, a chip card connected to the terminal for the occasion. The terminal may also contain a biometric sensor 102 having the same function as in the case shown in FIG. 7.

Verification is made with respect to an independent reference of the terminal 8 that has previously been stored on the external support 500 and that is designated by the identifier present in the access condition.

1. Method for authenticating a user possessing an access right to a digital content via a terminal equipment (8), characterized by the fact that it includes:
a configuration phase consisting of assigning to the user, via a trust third party, an exclusive reference independent of the terminal equipment, previously correlated with a user identifier, and in a one-to-one relation with personal information which the user should supply in order to be authenticated,
a phase in which the afore-mentioned user identifier is associated with a condition for accessing the said content,
a verification phase executed locally at the terminal equipment, consisting of verifying the above-mentioned one-to-one relation between the personal information supplied by the user and the reference assigned to the user, and
a decision-making phase executed locally in the terminal equipment and consisting of authorizing or prohibiting access to content according to the result of the above verification.

2. Method according to claim 1, characterized by the fact that the above correlation is a strict equality between the information supplied by the user and the reference assigned to him.

3. Method according to claim 1, whereby the verification phase is activated in response to the afore-mentioned condition for accessing content.

4. Method according to claim 1, whereby the above reference is stored on a remote identity server (44, 440).

5. Method according to claim 1, whereby the verification phase is executed by the afore-mentioned identity server (44, 440) at the request of the terminal equipment (8).

6. Method according to claim 1, whereby the above reference is stored on a secured detachable support (100, 500) associated with the terminal equipment (8).

7. Method according to claim 1, whereby the verification phase is executed by a security processor (26) associated with the terminal equipment (8).

8. Method according to claim 1, whereby the verification of the afore-mentioned predefined correlation between the user datum and the reference is carried out according to a security level agreed between the supplier of the right of access and the identity server.

9. Method according to claim 1, whereby the said content represents audio data, video data or multimedia data.

10. Method according to claim 9, whereby use of the said content is subjected to access conditions sent to the terminal equipment (8) in ECM messages.

11. Method according to claim 9, whereby use of the said content is subjected to access conditions sent to the terminal equipment (8) in a DRM licence.

12. Terminal equipment (8) intended to receive a digital content, including a control module (10, 24) for verifying a user's right to access to the digital content, equipment characterized by the fact that it also contains a ‘trust’ module (40, 400) cooperating with an identity server (44, 440) to authenticate the user with respect to an independent reference of the terminal equipment
